(19) United States
(12) Patent Application Publication
(10) Pub. No.: US 2006/0197342 A1
(43) Pub. Date: Sep. 7, 2006

(54) Connector for bridging a control stop and a flush valve

(75) Inventor: Chih-Chen Yen, Taipei City (TW)

Correspondence Address: TROXELL LAW OFFICE PLLC, SUITE 1404, 5205 LEESBURG PIKE, FALLS CHURCH, VA, 22041, US

(73) Assignee: Flushtech Corporation

(21) Appl. No.: 11/068,818

(22) Filed: Mar. 2, 2005

(51) Int. Cl. F16L 27/12; F16L 15/02

(52) U.S. Cl. 285/298; 285/32; 285/145.1; 285/302; 285/357

(57) ABSTRACT

A connector to bridge a control stop and a flush valve of a flushing system includes a connection duct which has an external screw thread to couple with a water inlet end of the flush valve, a bushing which has an external screw thread to couple with a middle portion of the interior of the connection duct and another end inserting into a water discharge tube of the control stop, and a first flange extended outwards on another end close to the connection duct, and an adjusting nut which has a second flange extended inwards to be coupled between one end of the connection duct facing the control stop and the first flange of the bushing. Thus by turning the adjusting nut to move the water discharge tube close to or away from the flush valve, the interval between the control stop and the flush valve may be adjusted. The screwing forces can resist the water pressure from the control stop to the flush valve, and prevent water leakage from occurring on the coupling portions.

### BACKGROUND OF THE INVENTION

1. Field of the Invention

The invention relates to a connector and particularly to a connector to bridge a control stop and a flush valve of a toilet flushing system that is adjustable to facilitate coupling.

2. Description of the Prior Art

The flush system for a conventional flush toilet, referring to FIG. 1, generally includes a control stop 11 and a flush valve 12. The control stop 11 is coupled with a water intake pipe embedded in a wall. The control stop 11 is connected to the flush valve 12 through a connector 13. When a solenoid valve 121 or a pushbutton 122 of the flush valve 12 is activated to flush, water enters the toilet through the control stop 11 and the flush valve 12. As the water outlet end of the water intake pipe coupled with the control stop 11 and one end of the flush valve 12 that is coupled with the toilet have a tolerance, the control stop 11 and the flush valve 12 cannot be coupled in a fixed dimension. An adjustment means is needed to adjust the coupling interval. FIG. 2 shows a conventional connector 13 for adjusting purpose. It has a conical outer duct 131 with an external screw thread 132 to fasten to the flush valve 12, and another end 133 coupled with a sealing ring 134 and extended into a water discharge tube of the control stop 11 to form a movable coupling. The conical outer duct 131 of the connector 13 is movably coupled with a nut 135, and a fastening ring 136 is coupled between the conical outer duct 131 and the nut 135. When the positions of the control stop 11 and the flush valve 12 are determined, fasten the fastening ring 136 between an inner end of the nut 135 through the adjusting nut 135 and the distal end of the water discharge tube of the control stop 11, the fastening ring 136 compresses the outer surface of the conical outer duct 131. Therefore the connector 13, besides bridging the interval of the control stop 11 and the flush valve 12, also can resist the thrust of water pressure from the control stop 11 to the flush valve 12 to prevent the flush valve 12 from being dislocated and causing water leakage at the coupling juncture with the toilet.

Although the connector 13 previously discussed can adjust the interval between the control stop 11 and the flush valve 12, its resistance against the water pressure from the control stop 11 to the flush valve 12 is not adequate. The flush valve 12 is pushed every time the flushing takes place. And the coupling juncture with the toilet tends to loosen after a period of time, and water leakage happens. This is because the coupling fastening ring 136 and the surface of the conical duct 131 are coupled in a circular fashion to minimize the friction to make moving and adjustment of the interval easier, in the event that the friction, even with the fastening ring 136 clamped by the adjusting nut 135 and the control stop 11, is smaller than the water pressure from the control stop 11 to the flush valve 12, the adjustment portion of the connector 13 will loosen, and the flush valve 12 is moved and dislocated.

### SUMMARY OF THE INVENTION

The primary object of the present invention is to provide a connector to bridge a control stop and a flush valve to facilitate adjustment of the interval between the control stop and the flush valve.

Another object of the invention is to provide a connector that can resist the thrust of water pressure on the flush valve from the control stop and prevent water leaking on the coupling juncture of the flush valve and the toilet.

To achieve the foregoing objects, the connector according to the invention bridges a control stop and a flush valve of a flushing system. It includes a connection duct which has one end screwing on a water inlet end of the flush valve, a bushing which has one end screwing on a middle portion of the connection duct and other end inserting into a water discharge tube of the control stop, and a first flange extending outwards close to the one end which is coupled with the connection duct, and an adjusting nut which has one end with a second flange extending inwards to be coupled between other end of the connection duct facing the control stop and the first flange of the bushing. The adjusting nut is turnable between the connection duct and the bushing. The adjusting nut further is screwed on the perimeter of the water discharge tube of the control stop. Therefore the connection tube and the bushing maintain in a still condition. By turning the adjusting nut, it may be moved close to or away from the flush valve to adjust the distance between the control stop and the flush valve.

By means of the connector set forth above, fine tuning of the interval adjustment may be accomplished by screwing and a secured anchoring may be achieved after the adjustment is finished. Moreover, coupling by screwing can resist the water pressure from the control stop to the flush valve, and prevent the flush valve from being dislocated that occurs to the conventional techniques when subject to water pressure.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional connector in a use condition;

FIG. 2 is a sectional view of the connector shown in FIG. 1;

FIG. 3 is a schematic view of the connector of the invention in a use condition;

FIG. 4 is a sectional view of the connector shown in FIG. 3; and

FIG. 5 is a fragmentary sectional view of the connector shown in FIG. 3.

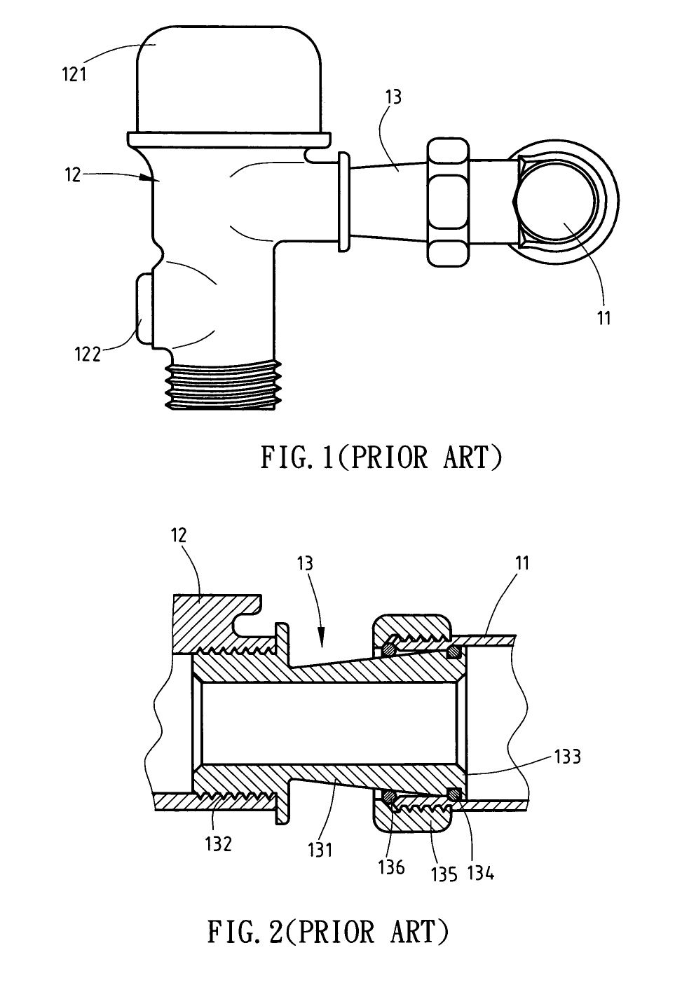

### DESCRIPTION OF THE PREFERRED EMBODIMENTS

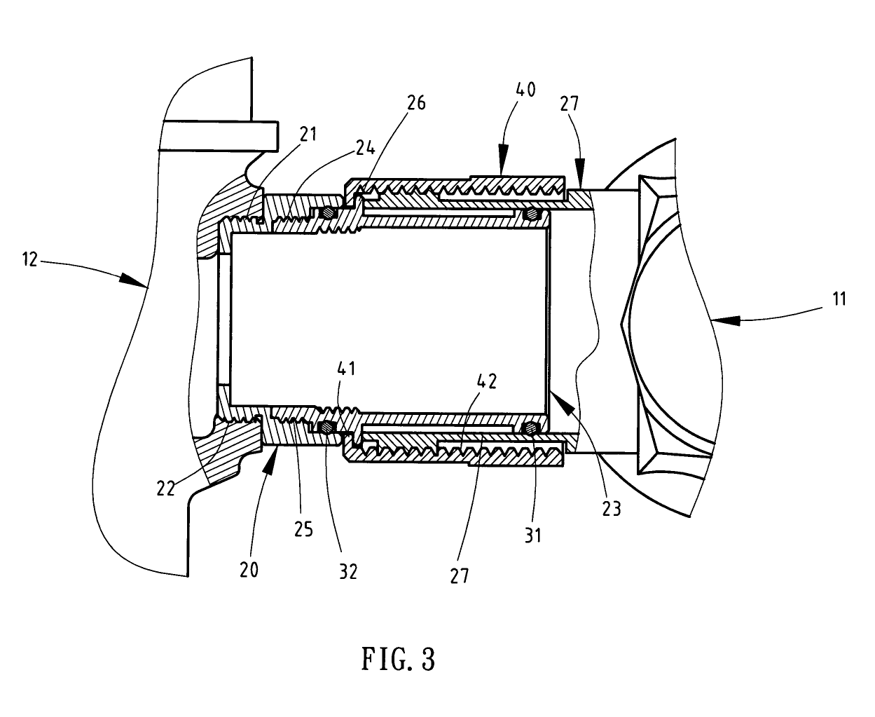

Refer to FIG. 3 for an embodiment of a connector 2 of the invention. It aims to bridge a control stop 11 and a flush valve 12 as a conventional connector does. It includes a connection duct 20 which has an external screw thread 21 on one end to couple with an internal screw thread 22 of a water inlet end of the flush valve 12, a bushing 23 which has an external screw thread 24 on one end to couple with an internal screw thread 25 formed in a middle portion of the connection tube 20 and a first flange 26 extended outwards on the end close to the connection duct 20. The bushing 23 has the another end inserting into a water discharge tube 27 of the control stop 11. The bushing 23 also is coupled with sealing rings 31 and 32 that are located on the junctures where the bushing 23 is coupled with the water discharge tube 27 and the connection tube 20. An adjusting nut 40 is provided that has a second flange 41 extending inwards to be coupled between the one end of the connection tube 20 facing the control stop 11 and the first flange 26 of the bushing 23, and being spaced respectively form the connection tube 20 and the bushing 23 for a small gap 51 and 52 as shown in FIG. 5. When the bushing 23 is screwed to the bottom of the connection tube 20, the first flange 26 does not compress the second flange 41 of the adjusting nut 40. Hence after the connection tube 20, bushing 23 and the adjusting nut 40 are coupled together, the adjusting nut 40 may be turned freely between the connection tube 20 and the bushing 23. The internal screw thread 42 of the adjusting nut 40 is coupled with the external screw thread 43 of the water discharge tube of the control stop 11. In the embodiment of the invention, the external screw thread 43 may is formed on a small portion on the perimeter of the water discharge tube 27 of the control stop 11 to enable the adjusting nut 40 to be turned and moved thereon.

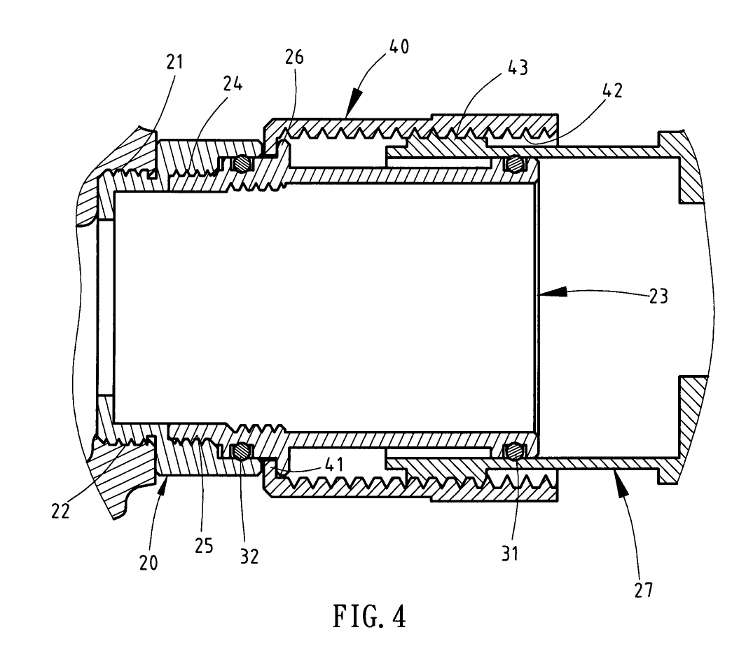

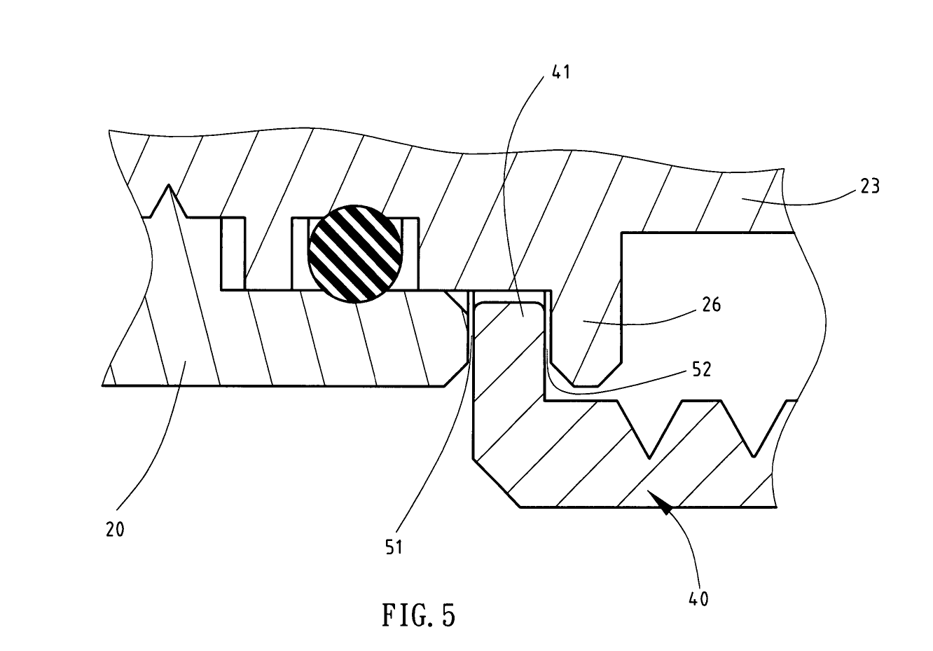

By means of the construction of the connector 2 set forth above, the connection duct 20 and the bushing 23 are maintained in a still condition. The second flange 41 of the adjusting nut 40 is loosely confined between one end of the connection tube 20 and the first flange 26 of the bushing 23, thus it can be turned only on the original location without moving leftwards or rightwards. But as the adjusting nut 40 is turned as previously discussed, the water discharge tube 27 of the control stop 11 that is screwed thereon can be moved close to the flush valve 12 or moved away, therefore can adjust the distance between the control stop 11 and the flush valve 12. Referring to FIG. 3, when a distal end of the water discharge tube 27 presses one side of the first flange 26 of the bushing 23, the interval between the control stop 11 and the flush valve 12 is most close. The distance between the control stop 11 and the flush valve 12 shown in FIG. 4 is greater than that shown in FIG. 3.

By means of the connector set forth above, the elements are coupled by screwing. It is the most secured coupling method, and can prevent dislocation of the flush valve caused by the water pressure from the control stop. Moreover, coupled by screwing can fine tune the distance without altering the interval. These characteristics can maintain the control stop and the flush valve at steady positions without causing water leakage on the coupling junctures.

While the preferred embodiment of the invention has been set forth for the purpose of disclosure, modifications of the disclosed embodiment of the invention as well as other embodiment thereof may occur to those skilled in the art. Accordingly, the appended claims are intended to cover all embodiments which do not depart from the spirit and scope of the invention.

I claim:

1. A connector for bridging a control stop and a flush valve, comprising:
a connection duct which has an external screw thread on one end to couple with internal screw threads formed on a water inlet end of the flush valve;
a bushing which has an external screw on one end to couple with internal screw threads formed on a middle portion of the connection duct and other end inserted into a water discharge tube of the control stop, and a first flange extended outwards and located on the one end close to the connection duct; and
an adjusting nut which has a second flange extended inwards on one end to be coupled between the other end of the connection duct facing the control stop and the first flange of the bushing, and internal screw threads to be coupled with external screw threads of the water discharge tube of the control stop.

2. The connector of claim 1, wherein the second flange of the adjusting nut is spaced from the connection duct and the bushing for a small gap to allow the adjusting nut to be turned freely between the connection duct and the bushing.

3. The connector of claim 1, wherein the external screw threads on the water discharge tube of the control stop are formed on a small portion.

4. The connector of claim 1, wherein the bushing and the water discharge tube and the connection duct are coupled with each other at a juncture which has a sealing ring.
